(19) United States
(12) Patent Application Publication
(10) Pub. No.: US 2008/0062182 A1
(43) Pub. Date: Mar. 13, 2008

(54) Control of color depth in a computing device

(75) Inventors: Neal A. Osborn, Milpitas, CA (US); Kenneth D. Comstock, Cupertino, CA (US)

Correspondence Address: FOLEY & LARDNER LLP, 777 EAST WISCONSIN AVENUE, MILWAUKEE, WI, 53202-5306, US

(73) Assignee: Palm, Inc.

(21) Appl. No.: 11/891,320

(22) Filed: Aug. 9, 2007

Related U.S. Application Data
(63) Continuation of application No. 09/726,831, filed on Nov. 30, 2000.

(51) Int. Cl. G06F 15/00

(52) U.S. Cl. 345/501

(57) ABSTRACT

A computing device, such as a hand-held computing device, like a personal digital assistant (PDA), includes a communications bus and a display configured to display in more than one display mode and the display coupled to the communications bus. The computing device also includes a processor coupled to the display and to the communications bus and a memory coupled to the communications bus. The memory is controlled by a display logic to manage the memory and allocate the memory according to the display mode.

### FIELD OF THE INVENTION

The disclosure relates to a system for managing display data in a computing device. Further, the disclosure relates to a system for managing memory in a unified memory architecture according to display requirements for a software application. Yet further still, the disclosure relates to a system for managing display data in a unified memory architecture for a palm-held device or a personal digital assistant (PDA).

### BACKGROUND OF THE INVENTION

Handheld computing devices, “palmtops”, or “palmhelds”, PDAs or hand-held computers typically weigh less than a pound and fit in a pocket. These palmhelds generally provide some combination of personal-information management, database functions, word processing and spreadsheets. Because of the small size and portability of palmhelds, strict adherence to hardware constraints, such as power and memory constraints, must be maintained.

It is conventional to employ a unified memory architecture in computing devices such as palmhelds. In a unified memory system, the main memory conventionally includes a portion allocated as a frame buffer for the system display. The frame buffer is configured to hold one frame of display data. The central processor and display controller share the memory, and the display controller must share bus bandwidth with the central processor in order to interleave its fetches from the memory required to refresh the display. When the main memory would be otherwise powered down, it must be kept active in order to service the display controller. This may represent a power drain an order of magnitude greater than if the main memory could power down in such circumstances.

Many prior art systems utilize a frame buffer which is separate from the main memory. Providing an additional one to two megabytes, or even 128 kilobytes, of memory significantly increases the cost of the computing device. Accordingly, many computing devices continue to use unified memory architectures, and the bandwidth deficiencies and power requirements mandated by the use of the unified memory architecture have gone largely unaddressed.

Accordingly, there is a need for a memory architecture for a computing device including display logic that is configured to manage the memory and allocate the memory according to a display mode. Further, there is a need for a personal digital assistant utilizing a unified memory architecture, the unified memory being controlled by display logic that is configured to manage the unified memory and allocate the unified memory according to the display mode.

### SUMMARY OF THE INVENTION

An exemplary embodiment of the invention relates to a computing device. The hand-held computing device includes a communications bus and a display configured to display in more than one display mode and coupled to the communications bus. The computing device also includes a processor coupled to the display and to the communications bus and a memory coupled to the communications bus. The memory is controlled by a display logic to manage the memory and allocate the memory according to the display mode and the display logic is configured to change the display mode during operation of the computing device.

Another exemplary embodiment of the invention relates to a personal digital assistant. The PDA includes a communications bus and a display configured to display in more than one display mode and coupled to the communications bus. The PDA also includes a processor, coupled to the display and to the communications bus. The PDA further includes a unified memory, the unified memory configured to receive and provide access to display information to be communicated to the display. The unified memory is controlled by the display logic and the display logic is configured to manage the unified memory and allocate the unified memory according to the display mode and the display logic is configured to change the display mode during operation of the personal digital assistant.

Yet another exemplary embodiment relates to a computing device. The computing device includes a communication bus and a display configured to display in more than one display mode and coupled to the communications bus. The computing device also includes a processor coupled to the display and to the communications bus. The computing device further includes a unified memory coupled to the communications bus. The unified memory is configured to receive and provide access to display information to be communicated to the display The unified memory is controlled by display logic. The display logic is configured to manage the unified memory and allocate the unified memory according to the display mode and the display logic being configured to change the display mode during operation of the computing device. Further still, the computing device includes a display controller. The display controller is configured to perform the display logic.

### BRIEF DESCRIPTION OF THE DRAWINGS

The invention will become more fully understood from the following detailed description, taken in conjunction with the accompanying drawings, wherein like reference numerals refer to like elements, in which:

FIG. 1 is a depiction of a hand-held computer;

FIG. 2 is a block diagram of an exemplary bus architecture of the prior art, for a hand-held computer; and

FIG. 3 is an exemplary block diagram of a bus architecture for the hand-held computer of FIG. 1.

### DETAILED DESCRIPTION OF EXEMPLARY EMBODIMENTS

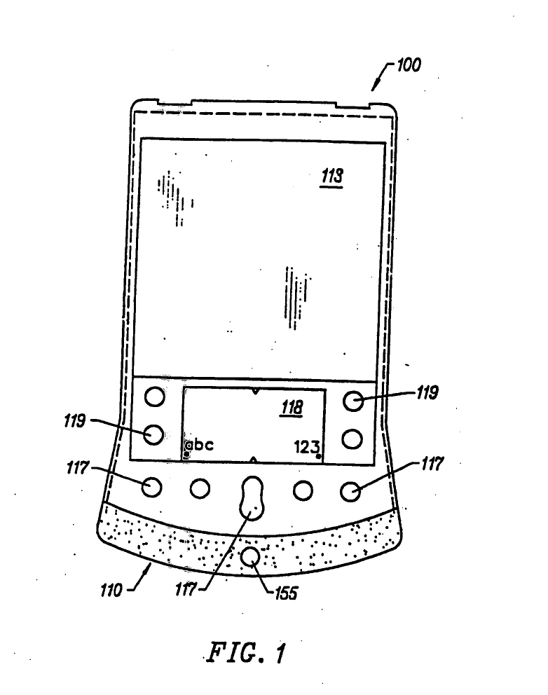

Referring to FIG. 1, a hand-held computer 100 is depicted, being optionally detachably coupled to an accessory device 110 according to an exemplary embodiment. Hand-held computer 100 may include Palm style computers such as, but not limited to, Palm Pilot™, Palm III™, Palm IIIc™, Palm V™, Palm VII™, Palm M100™ organizers, manufactured by Palm, Inc., of Santa Clara, Calif. Other exemplary embodiments of the invention may include Windows CE™ hand-held computers, or other hand-held computers and personal digital assistants, as well as cellular telephones, and other mobile computing devices. Further, hand-held computer 100 may be configured with or without accessory device 110 or optionally with any of a variety of other accessory devices.

Preferably, hand-held computer 100 includes interactive hardware and software that performs functions such as maintaining calendars, phone lists, task lists, notepads, calculation applications, spreadsheets, games, and other applications capable of running on a computing device. Hand-held computer 100, shown in FIG. 1 includes a plurality of input functions, keys 117 and a display 113 having graphical user interface features. Display 113 may be provided with an interface that allows a user to select and alter displayed content using a pointer, such as, but not limited to, a stylus. In an exemplary embodiment, display 113 also includes a Graffiti™ writing section 118, or other handwriting recognition software, for tracing alphanumeric characters as input. A plurality of input buttons 119 for performing automated or preprogrammed functions may be provided on a portion of display 113. In a particular embodiment, display 113 is a touch screen display that is electronically responsive to movements of a stylus on the surface of display 113.

Accessory device 110 may be one of several types of accessories, such as, but not limited to, a modem device for serial and/or wireless data communications, a Universal Serial Bus (USB) device, or a communication cradle having an extended housing. Accessory device 110 may include one or more ports for parallel and/or serial data transfer with other computers or data networks. Hand-held computer 100 may use the accessory device 110 for the purpose of downloading and uploading software and for synchronizing data on hand-held computer 100 with a personal computer, for example. Accessory device 110 couples to hand-held computer 100 through an electrical connector located at a bottom portion of its front face. Button 155 on accessory 110 may effectuate an electrical connection between accessory device 110 and hand-held computer 100 when the two are connected.

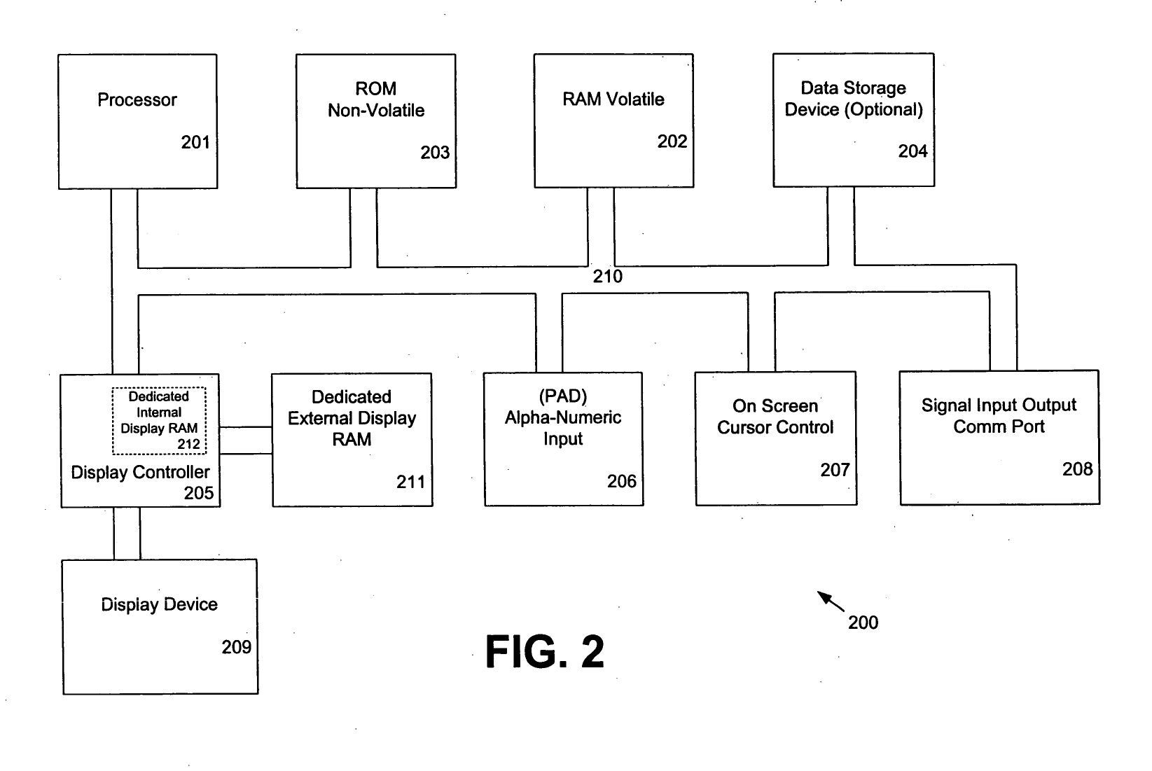

Referring now to FIG. 2, an exemplary communication bus architecture 200 is depicted. Bus architecture 200 includes a processor 201, a random access volatile memory 202, a read-only non-volatile memory (ROM) 203, a data storage device 204 which may be an optional device, such as a disk drive, hard disk drive, optical disk drive, flash memory, or the like. Processor 201, RAM 202, ROM 203, and data storage device 204, are coupled to and in communication with a communications bus 210. Further, coupled to and in communication with communications bus 210 are a display controller 205, an alphanumeric input 206, an on-screen cursor control 207, a signal input/output communications port 208, and a dedicated external display RAM 211. Yet further still, display device 209 is coupled to display controller 205 (display controller 205 may be, but is not limited to, a Seiko Epson 1375 display controller). In an optional exemplary configuration (e.g. the Palm IIIc™), display controller 205 includes a dedicated internal display RAM 212 instead of dedicated external display RAM 211.

In operation, processor 201 runs program applications stored in ROM 203, RAM 202, and/or data storage device 204. Many of these applications require screen displays. For example, some applications, such as, but not limited to, memo pads, date books, contacts or telephone books, etc., require only textual types of graphical information to be displayed on display 113. However, other types of graphical information may require greater color depth, and/or greater resolution, such as, but not limited to, map displays, Chinese characters, games, etc. Further, other applications may require a very high resolution and very high color depth, including such applications that require the display of photographic images and the like. Conventionally, such computing devices that were capable of displaying high resolution graphics with high color depth, operated in such a high resolution and/or high color depth mode at the request of a user, and thereby paid a penalty in available bandwidth on communication bus 210, computational speed, and power requirements because of the large number of memory accesses required to continually refresh display 113.

In the exemplary embodiment of FIG. 2, display controller 205 (or processor 201) is configured to run a display logic (or other software for controlling display 13) which utilizes dedicated external display RAM 211 and dedicated internal display RAM 212 to provide display information to display device 209. In an exemplary embodiment, the display logic provides that dedicated external display RAM 211 and dedicated internal display RAM 212 operate in different display modes, according to either the application running on processor 201 and/or requirements dictated by an operating system running on processor 201. For example, should the application running on processor 201 require a high resolution and high color depth display mode, the display logic or display controller 205 would dictate that dedicated external display RAM 211 and dedicated internal display RAM 212 perform a high number of memory accesses to retrieve the necessary information for displaying rich color and high resolution on display device 209. Similarly, should the application and/or the operating system running on processor 201 require only a low color depth or low resolution for display device 209, the display logic for display controller 205 allows accesses to smaller portions of dedicated external display RAM 211 and dedicated internal display RAM 212, such that smaller amounts of information are accessed and retrieved by display controller 205 to be displayed on display device 209.

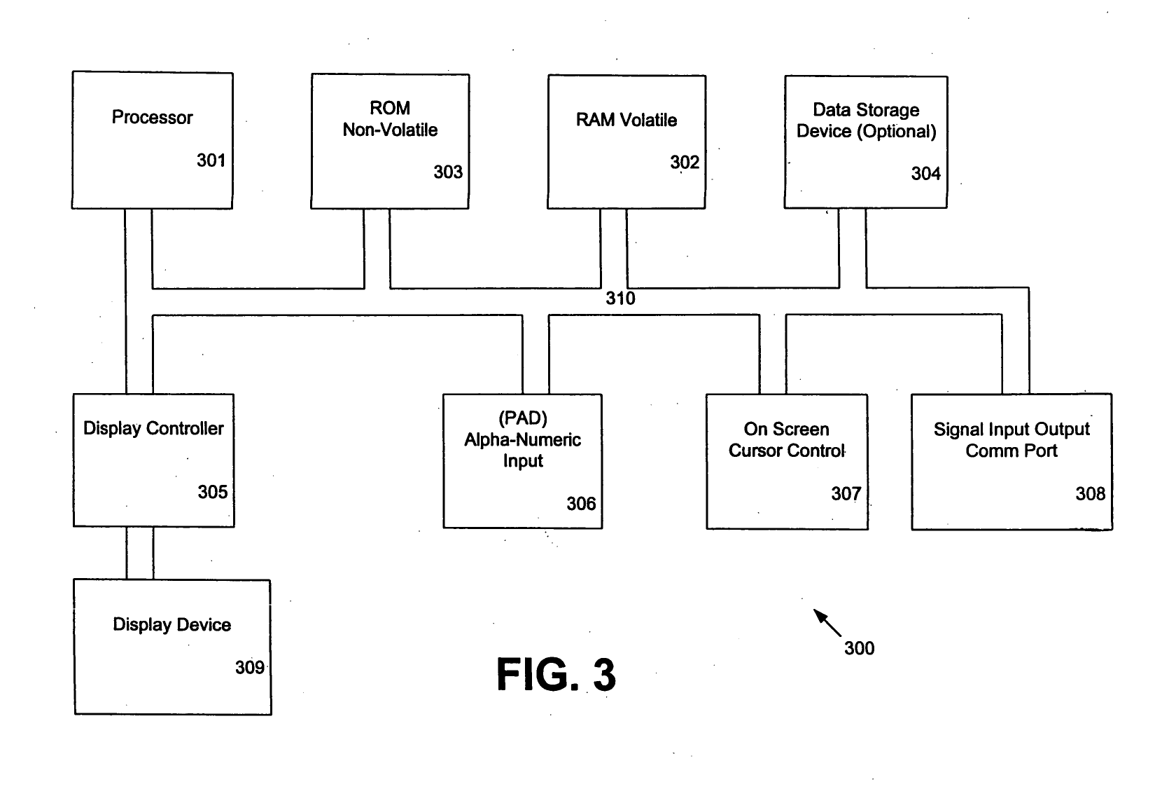

Referring now to FIG. 3, a communication bus architecture 300 is depicted. Communication bus architecture 300 includes a processor 301, a ROM non-volatile memory 303, a RAM volatile memory 302, and an optional data storage device 304, all coupled to and in communication with communications bus 310. Also coupled to communications bus 310 are a display controller 305, an alpha-numeric input 306, an on-screen cursor control 307, and a signal input/output communication port 308. Display controller 305 is further in communication with a display device 309. In the exemplary embodiment depicted in FIG. 3, RAM volatile memory 302 acts as a unified memory architecture in which at least a portion of RAM volatile memory 302 is allocated as a frame buffer while another portion is allocated as a main memory portion for running applications on processor 301 and other memory allocations.

Display controller 305 (or processor 301) is configured with display logic to extract display information from the frame buffer portion of memory 302. Similar to the display logic of FIG. 2, display controller 305 utilizes display logic in which the frame buffer portion of RAM 302 is dependent upon the application running on processor 301 and/or the mode of operation of the operating system running on processor 301. Accordingly, should the application running on processor :301 require that display device 309 display images with rich color depth and/or high resolution, a high resolution mode and/or a high color mode would be used and the frame buffer of RAM 302 would be sized accordingly. Therefore, in such an instance, a large number of memory accesses would be required by display controller 305 over communications bus 310. Should the application running on processor 301 require a low resolution and/or a low color mode, the frame buffer of RAM 302 would be sized accordingly smaller, and therefore, less information would need to be passed from the frame buffer of RAM 302 to display controller 305 when operating in a low color or low resolution mode. Therefore, the bandwidth required to provide display information to display device 309 would be significantly less than when the device operates in a high color and/or a high resolution mode. The bandwidth requirements of the device running in a low color and/or low resolution mode are significantly less than when the device is running in a high color or high resolution mode. Similarly, because less information is passed between memory 302 and display controller 305 when in a low resolution mode, the power requirements to constantly refresh the screen of display device 309 is significantly less than when the device is operating in a high color and/or high resolution mode.

Because of cost and size, small hand-held computers typically use the unified memory architecture depicted in FIG. 3. Also, because it is becoming more desirable to display more color simultaneously and to increase the number of picture elements (pixels) displayed on display device 309, the amount of data that must be moved from the video frame buffer of RAM 302 into the graphics control circuitry of display controller 305, is greatly increased. For example, to display two colors (a black and white or a monochrome display) at a resolution of 160 pixels by 160 pixels (25,600 pixels) at a refresh rate of 64 hertz requires accessing (160 pixels×160 pixels×64 hertz×1 bit per pixel=) 1,638,400 bits per second. Likewise, a display capable of showing 65,536 simultaneous colors (frequently considered necessary to display “true color”) at a resolution of 320 pixels by 320 pixels (102,400 pixels) at a refresh rate of 64 hertz requires accessing (320×320×64 hertz×16 bits per pixel=) 104,857,600 bits each second (however, typical displays may be refreshed at rates ranging from 60-80 Hz or any other applicable rate). Accordingly, a rich color display requires significantly greater memory bandwidth than a typical black and white or monochrome display. However, such bandwidth is difficult to implement in small, portable hand-held computers. Additionally, video memory accesses required by a rich color display consume a proportionately greater share of the available memory bandwidth, reducing the memory bandwidth available for other tasks, such as computation. Further, memory accesses at such a rate, especially when the memory is physically separated from the video display control logic, as in the unified memory architecture embodied in FIG. 3, consume vast amounts of power. For this reason, many hand-held computers incorporating a color display, such as the Palm IIIc™, employ a separate memory more similar to the exemplary embodiment depicted in FIG. 2 partitioned to contain the video frame buffer.

As explained above, the use of display logic that is based on application display requirements allows a rich display to operate in conjunction with computation means in a unified memory architecture by managing the color depth (the number of colors simultaneously displayed) according to the requirements of the displayed application. Many applications, for example, a phone list require very few colors to convey the required visual information such as text and highlighting. Such geographically rich materials as geographic maps typically use only a handful of colors. Only the display of photographs and similar material (e.g., moving pictures) require as many as 65,000 colors. Accordingly, the display mode of the video display control logic is changed according to the needs of each application. Although the memory must be capable of displaying the richest image with the greatest color depth, the display will most often be operated in a much less color rich mode, requiring significantly less memory accesses, allowing that portion of the total bandwidth to be shared by other operations if necessary, and saving power when not in use. Further, it may be desirable to choose a display mode based on other factors, such as, but not limited to, available unified memory space, available power, or available bandwidth on the communications bus. Further still, the display logic program may choose from a wide range of display modes, such as, but not limited to, 64 bit color, 32 bit color, 24 bit color, 18 bit color, 16 bit color, 8 bit color, monochrome, text, high resolution, low resolution, medium resolution.

While the detailed drawings, specific examples and particular formulations given describe exemplary embodiments, they serve the purpose of illustration only. The hardware and software configurations shown and described may differ depending on the chosen performance characteristics and physical characteristics of the computing devices. For example, the type of computing device or communications bus used may differ. The systems shown and described are not limited to the precise details and conditions disclosed. Furthermore, other substitutions, modifications, changes, and omissions may be made in the design, operating conditions, and arrangement of the exemplary embodiments without departing from the scope of the invention as expressed in the appended claims.

1-30. (canceled)

31. A mobile computing device, comprising:
a memory;
a display configured to display in more than one display mode;
a display controller coupled to the display and comprising an internal display memory;
a processor coupled to the memory and the display controller:, wherein one of the processor and display controller is configured to operate display logic configured to change the display mode,
wherein in a first display mode the display controller is configured to retrieve a first amount of information from the memory to be displayed on the display, and
in a second display mode the display controller is configured to retrieve a second amount of information smaller than the first amount of information from the internal display memory to be displayed on the display.

32. The mobile computing device of claim 31, wherein the first amount of information is sufficient for displaying rich color and high resolution on the display and the second, smaller amount of information is for displaying low color and low resolution on the display.

33. The mobile computing device of claim 32, wherein in the second mode only textual types of graphical information are displayed.

34. The mobile computing device of claim 31, wherein the processor is configured in the first mode to operate a first application stored in memory and in the second mode to operate a second application stored in memory.

35. The mobile computing device of claim 31, wherein the display logic is configured to change the display mode based on requirements dictated by an operating system running on the processor.

36. The mobile computing device of claim 31, wherein in the second mode the memory is powered down.

37. The mobile computing device of claim 31, wherein the internal display memory comprises random access memory.

38. The mobile computing device of claim 31, wherein the mobile computing device comprises a wireless data communications device, wherein the processor is configured to synchronize data with a computer.

39. The mobile computing device of claim 31, further comprising a cellular telephone.

40. A display controller, comprising:
an internal display memory;
display logic configured in a first display mode to retrieve a first amount of information from a memory to be displayed on a display and in a second display mode to retrieve a second amount of information smaller than the first amount of information from the internal display memory to be displayed on the display.

41. The display controller of claim 40, wherein the first amount of information is sufficient for displaying rich color and high resolution on the display and the second, smaller amount of information is for displaying low color and low resolution on the display.

42. The display controller of claim 40, wherein the display controller is configured to change modes based on logic operating on a processor coupleable to the display controller.

43. The display controller of claim 40, wherein the second mode is a low power mode.

44. The display controller of claim 40, wherein the internal display memory comprises random access memory.

45. A method of refreshing a display, comprising:
in a first display mode, retrieving a first amount of information from a first memory device to be displayed on the display, and
in a second display mode, retrieving a second amount of information smaller than the first amount of information from a second memory device to be displayed on the display.

46. The method of claim 45, wherein the first memory device is a main memory for an electronic device and the second memory device is an internal display memory of a display controller.

47. The method of claim 45, wherein the first amount of information is sufficient for displaying rich color and high resolution and the second, smaller amount of information is for displaying low color and low resolution on the display.

48. The method of claim 45, wherein in the second mode only textual types of graphical information are displayed.

49. The method of claim 45, wherein in the second mode the first memory device is powered down.

50. The method of claim 45, further comprising synchronizing data with a computer over a wireless communication interface.
